(19) United States
(12) Patent Application Publication
(10) Pub. No.: US 2016/0232651 A1
(43) Pub. Date: Aug. 11, 2016

(54) SIGNAL ADJUSTMENT APPARATUS, DISPLAY APPARATUS, AND SIGNAL ADJUSTMENT METHOD

(71) Applicant: Seiko Epson Corporation, Tokyo (JP)

(72) Inventor: Fumio Koyama, Shiojiri-shi (JP)

(21) Appl. No.: 15/005,960

(22) Filed: Jan. 25, 2016

(30) Foreign Application Priority Data
Feb. 6, 2015 (JP) 2015-021911

(51) Int. Cl. G06T 5/00; G09G 5/06

(52) U.S. Cl. CPC G06T 5/009; G09G 5/06; G09G 2320/0666; G09G 2320/066; G09G 2340/06; G06T 2207/20208

(57) ABSTRACT

An image processing unit includes an adjustment circuit that performs luminance adjustment on an input image signal containing elements formed of luminance, saturation, and hue in a polar coordinate system on a hue basis in accordance with an inputted adjustment value. The adjustment circuit reduces the width over which the luminance of a color in a low saturation area set with reference to the saturation is adjusted.

The entire disclosure of Japanese Patent Application No. 2015-021911, filed Feb. 6, 2015 is expressly incorporated by reference herein.

### BACKGROUND

1. Technical Field

The present invention relates to a signal adjustment apparatus that adjusts an image signal, a display apparatus, and a signal adjustment method.

2. Related Art

There is a known image display apparatus of related art that converts an inputted image signal into a signal in an HLS color space in which a color is expressed by a hue component, a luminance component, and a saturation component (see JP-A-2010-232773, for example). The thus converted image signal allows adjustment of the hue component, the luminance component, and the saturation component on a component basis.

To adjust the hue component, the luminance component, and the saturation component, it is conceivable to adjust the luminance on a hue basis. When the luminance is changed for a certain hue in the same manner over a range from a low saturation region to a high saturation region, however, the adjustment could cause an excessive change in the hue in the low saturation region due to the characteristics of the HLS color space. The excessive change undesirably amplifies noise contained in an image before the adjustment, possibly resulting in a decrease in image quality due to the adjustment.

### SUMMARY

An advantage of some aspects of the invention is to provide a signal adjustment apparatus, a display apparatus and a signal adjustment method capable of suppressing, in the process of performing luminance adjustment on an image signal on a hue basis, an effect of noise by performing intended, appropriate adjustment.

A signal adjustment apparatus according to an aspect of the invention includes an adjustment section that performs luminance adjustment on an input image signal containing elements formed of luminance, saturation, and hue in accordance with an adjustment value on a hue basis, and the adjustment section sets, for at least one hue, the amount of adjustment of the luminance in a low saturation area where the saturation is low to be smaller than the amount of adjustment of the luminance in an area where the saturation is higher than in the low saturation area.

According to the aspect of the invention, an effect of noise in the case where luminance adjustment is performed on an input image signal on a hue basis can be suppressed.

In the aspect of the invention, in the signal adjustment apparatus described above, the adjustment section may have a correction value used to correct an adjustment value used to adjust the luminance in the low saturation area and correct the adjustment value by using the correction value to determine a luminance adjustment value that specifies the amount of adjustment of the luminance.

According to the aspect of the invention with this configuration, a color in a low saturation area can also be appropriately adjusted on the basis of an inputted adjustment value.

In the aspect of the invention, in the signal adjustment apparatus described above, the adjustment section may include a subtraction circuit that corrects the adjustment value by using the correction value.

According to the aspect of the invention with this configuration, the subtraction circuit, which corrects the adjustment value, can quickly produce an adjustment value suitable for the low saturation area, whereby delay in processing can be suppressed.

In the aspect of the invention, the signal adjustment apparatus described above may further include an adjustment LUT created on the basis of an input value and a correction LUT containing the correction value, and the hue of the input image signal may be applied to the adjustment LUT to determine the adjustment value used to adjust the luminance, the saturation of the input image signal may be applied to the correction LUT to determine the correction value, and the correction value may be applied to the adjustment value used to adjust the luminance to determine the luminance adjustment value.

According to the aspect of the invention with this configuration, the computation using the adjustment LUT and the correction LUT allows quick generation of an appropriate adjustment value, and the signal adjustment with a small amount of delay in processing allows suppression of an effect of noise, whereby a high-quality image signal can be outputted.

In the aspect of the invention, in the signal adjustment apparatus described above, the adjustment section may include a luminance adjustment section to which a hue signal, a luminance signal, and a saturation signal that form the input image signal are inputted, and the luminance adjustment section may include an adjustment value setting section that applies the hue of the input image signal to the adjustment LUT to determine the adjustment value used to adjust the luminance, a correction value setting section that applies the saturation of the input image signal to the correction LUT to determine the correction value, a subtraction circuit that subtracts the correction value determined by the correction value setting section from the adjustment value determined by the adjustment value setting section to produce the luminance adjustment value, and a multiplication circuit that multiplies the luminance signal by the luminance adjustment value produced by the subtraction circuit.

According to the aspect of the invention with this configuration, appropriate adjustment can be made on the basis of the hue signal, the luminance signal, and the saturation signal that form the input image signal to suppress an effect of noise.

In the aspect of the invention, the signal adjustment apparatus described above may further include a conversion section that is connected to a signal input section to which an image signal is inputted and performs polar coordinate conversion on the image signal inputted to the signal input section, the polar coordinate conversion converting the image signal into the input image signal containing the elements formed of the luminance, the saturation, and the hue in a polar coordinate system.

According to the aspect of the invention with this configuration, luminance adjustment can be performed on a hue basis not only on an image signal in a polar coordinate system but also on an input image signal in any other color space.

In the aspect of the invention, in the signal adjustment apparatus described above, a YUV-color-space or RGB-color-space image signal inputted to the signal input section may be converted into an input image signal containing the elements formed of the luminance, the saturation, and the hue in a polar coordinate system, and the input image signal may be adjusted in accordance with the adjustment value, converted into a YUV-color-space or RGB-color-space image signal, and outputted.

According to the aspect of the invention with this configuration, luminance adjustment on a hue basis in a polar coordinate color space can be performed on a YUV-color-space or RGB-color-space image signal, and the adjusted image signal can be outputted in the form of a YUV-color-space or RGB-color-space image signal.

In the aspect of the invention, in the signal adjustment apparatus described above, adjustment values used to adjust the luminance, the saturation, and the hue may be allowed to be inputted for each of six colors, R, G, B, C, M, and Y, and six-axis adjustment in which the luminance, the saturation, and the hue of the six colors, R, G, B, C, M, and Y, are adjusted on the basis of the inputted adjustment values may be performed.

According to the aspect of the invention with this configuration, an effect of noise in the six-axis adjustment can be suppressed, whereby a high-quality image signal can be outputted.

A display apparatus according to another aspect of the invention includes a signal input section to which an image signal to be processed is inputted, a control section that sets an adjustment value used to adjust the image signal, an adjustment section that performs luminance adjustment on an input image signal containing elements formed of luminance, saturation, and hue on a hue basis in accordance with the adjustment value set by the control section, and a display section that displays an image on the basis of the image signal adjusted by the adjustment section, and the adjustment section sets, for at least one hue, the amount of adjustment of the luminance in a low saturation area where the saturation is low to be smaller than the amount of adjustment of the luminance in an area where the saturation is higher than in the low saturation area.

According to the aspect of the invention, an effect of noise in the case where luminance adjustment is performed on an input image signal on a hue basis can be suppressed, whereby a high-quality image can be displayed.

A signal adjustment method according to still another aspect of the invention includes performing luminance adjustment on an input image signal containing elements formed of luminance, saturation, and hue on a hue basis and setting, in the adjustment, for at least one hue, the amount of adjustment of the luminance in a low saturation area where the saturation is low to be smaller than the amount of adjustment of the luminance in an area where the saturation is higher than in the low saturation area.

According to the aspect of the invention, an effect of noise in the case where luminance adjustment is performed on an input image signal on a hue basis can be suppressed.

### BRIEF DESCRIPTION OF THE DRAWINGS

The invention will be described with reference to the accompanying drawings, wherein like numbers reference like elements.

FIG. 1 is a functional block diagram of a projector according to an embodiment.

FIG. 2 is a functional block diagram of an adjustment circuit provided in the projector.

FIGS. 3A to 3C describe action of the projector.

FIG. 4 is a flowchart showing action of the projector.

### DESCRIPTION OF EXEMPLARY EMBODIMENTS

An embodiment to which the invention is applied will be described below with reference to the drawings.

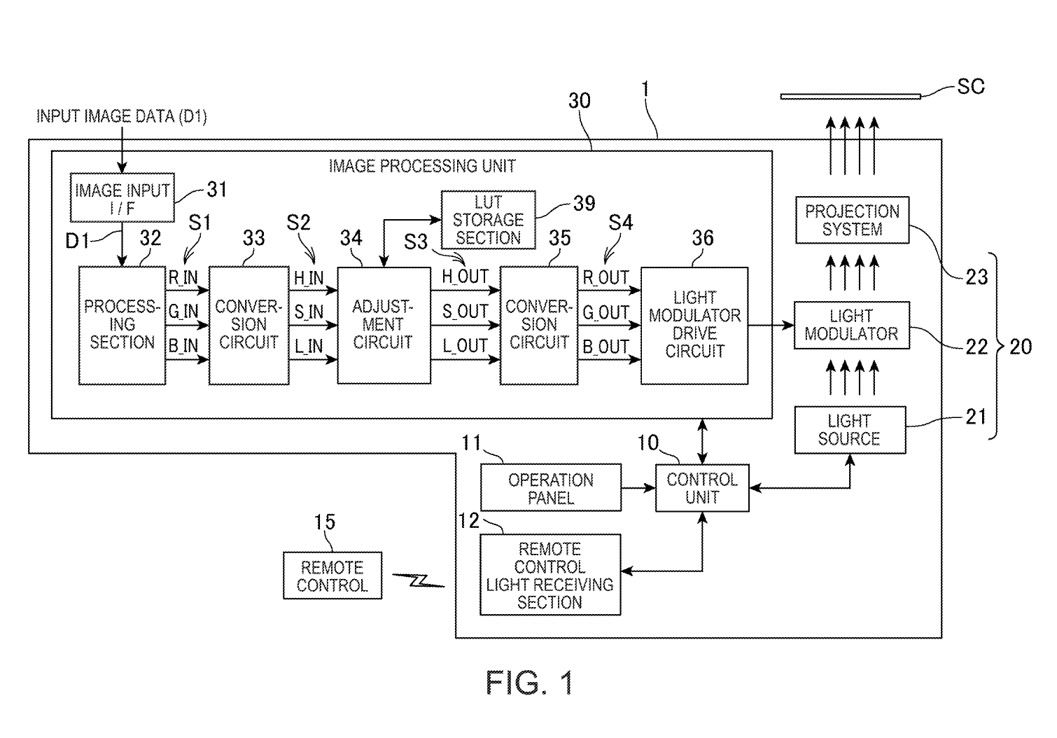

FIG. 1 is a functional block diagram of a projector 1 according to an embodiment to which the invention is applied.

The projector 1 (display apparatus) is connected to an image supply apparatus (not shown) and projects an image on a screen SC on the basis of input image data D1 outputted by the image supply apparatus.

The projector 1 includes a control unit 10, which controls each portion of the projector 1, an image processing unit 30 (signal adjustment apparatus), which processes the input image data D1 under the control of the control unit 10, and a projection unit 20 (display section), which project an image on the screen SC.

The projection unit 20 includes a light source section 21, a light modulator 22, which modulates light outputted by the light source section 21, and a projection system 23, which causes the light modulated by the light modulator 22 to converge and diverge to project the modulated light on the screen SC.

The light source section 21 includes a light source formed of a xenon lamp, an ultrahigh-pressure mercury lamp, an LED, or any other light source. The light source section 21 includes a drive circuit (not shown) that supplies the light source with drive current and turns on/off the light source under the control of the control unit 10. The light source section 21 may further include a reflector that guides light emitted from the light source to the light modulator 22, a lens group (not shown) for enhancing optical characteristics of projection light, a polarizer, a light control element that is disposed on the path to the light modulator 22 and attenuates the light emitted from the light source, and other components.

The light modulator 22 includes a liquid crystal panel or a digital mirror device (DMD) and modulates the light outputted by the light source section 21. For example, the light modulator 22 includes three transmissive liquid crystal panels corresponding to colors R, G, and B, and the transmissive liquid crystal panels are driven by a light modulator drive circuit 36, which will be described later. The light modulator 22 may, instead of including three transmissive liquid crystal panels, for example, include three DMDs or a combination of one transmissive liquid crystal panel or DMD and a color wheel.

The projection system 23 includes a prism that combines RGB three-color light fluxes modulated by the light modulator 22, a lens group that brings a combined projection image from the prism into focus on the screen SC, and other components.

An operation panel 11, which is disposed on the upper surface or the rear surface of a main body of the projector 1, is connected to the control unit 10. The operation panel 11 has a plurality of operation parts, produces an operation signal corresponding to operation performed on any of the operation parts, and outputs the operation signal to the control unit 10. A remote control light receiving section 12 is further connected to the control unit 10. The remote control light receiving section 12 receives an infrared light signal transmitted by a remote control 15, produces an operation signal corresponding to operation performed on the remote control 15, and outputs the operation signal to the control unit 10. The remote control 15 has a variety of keys that allow a user to operate the projector 1 and transmits an infrared light signal corresponding to operation performed on any of the keys. The remote control 15 has, for example, a power key that issues an instruction to power on/off the projector 1, numeral keys corresponding to numerals, and arrow keys or a cross-shaped key that specifies a direction.

The projector 1 receives an input in the form of digital image data from a storage device (not shown) built in the projector 1 or the external image supply apparatus (not shown), such as a personal computer and a variety of image players. The image signal inputted to the projector 1 may be formed of image data on a still image or image data on motion images (video images). The present embodiment will be described with reference to a case where image data on motion images is inputted by way of example. The input image data may be typical video data or stereoscopic video data.

The stereoscopic (3D) video data may be formatted by using a frame sequential method in which an image frame for the left eye (left image frame) and an image frame for the right eye (right image frame) are alternately inputted or a side-by-side method.

The image processing unit 30 processes the input image data D1 inputted from the built-in storage device or the external image supply apparatus. The image processing unit 30 includes an image input interface (I/F) 31, to which the input image data D1 is inputted, and a plurality of processing sections that process the input image data D1. Specifically, the image processing unit 30 includes a processing section 32, conversion circuits 33 (conversion section) and 35, an adjustment circuit 34 (adjustment section), a light modulator drive circuit 36, and an LUT (lookup table) storage section 39.

The input image data D1 inputted to the image input I/F 31 is image data stored in the storage device (not shown) built in the projector 1 or image data outputted by the image supply apparatus (not shown) external to the projector 1. The image input I/F 31 may include a connector and an interface circuit connected to the image supply apparatus, or the projector 1 may be provided with a connector and an interface circuit separate from the image input I/F 31. Further, the image input I/F 31 may be configured to be capable of receiving an input in the form of an analog image signal. In this case, the image input I/F 31 may include an A/D converter or any other component that converts the analog image signal to digital image data and output the converted digital image data to the processing section 32.

The image input I/F 31 outputs the input image data D1 to the processing section 32. The processing section 32 performs a variety of types of image processing on the input image data D1. Specific examples of the image processing performed by the processing section 32 may include discrimination between a 3D (stereoscopic) image and a 2D (planar) image, resolution conversion, frame rate conversion, 3D image conversion, distortion correction, and zooming. A plurality of the types of image processing described above can be performed in combination with each other, and a result of the processing may be outputted to the control unit 10. The resolution conversion is the process of converting the resolution of the input image data D1 in accordance with the drawing resolution of the light modulator 22. The frame rate conversion is the process of converting the frame rate of the input image data D1 in such a way that the converted frame rate adapts to processing burden on and other factors of the image processing unit 30. The 3D image conversion is the process of converting 3D video data in the side-by-side format or the top-and-bottom format into video data in the frame-sequential format. The distortion correction is the process of deforming an image in such a way that trapezoidal distortion or pincushion distortion of an image projected on the screen SC is compensated. The zooming is the process of enlarging or reducing a specific range or the entirety of a frame of the input image data D1 at a specified enlargement or reduction factor. The processing section 32 may omit the image processing described above.

The processing section 32 produces an image signal based on the processed image data and outputs the image signal to the conversion circuit 33. The signal outputted by the processing section 32 to the conversion circuit 33 is called hereinafter an image signal S1. In the present embodiment, the image signal S1 is an image signal in a three-dimensional color space and particularly contains an R (red) image signal, a G (green) image signal, and a B (blue) image signal by way of example. The image signal S1 may instead, for example, be an image signal in the YUV color space formed of Y (luminance signal), U (first color difference signal), and V (second color difference signal), an image signal in the YCbCr color space, or an image signal in the YPbPr color space.

The conversion circuit 33 converts the image signal S1 outputted by the processing section 32 into an image signal in a color space of a polar coordinate system and outputs an input image signal S2, which is to be processed by the adjustment circuit 34, to the adjustment circuit 34. In the present embodiment, the conversion circuit 33 converts the RGB color space to the HLS color space formed of H (hue), S (saturation), and L (luminance). In this case, the input image signal S2 contains a hue input signal H_IN, a saturation input signal S_IN, and a luminance input signal L_IN.

The adjustment circuit 34 adjusts the input image signal S2 in terms of the hue, saturation, and luminance and outputs an output image signal S3 having undergone the adjustment to the conversion circuit 35. The output image signal S3 contains a hue output signal H_OUT, a saturation output signal S_OUT, and a luminance output signal L_OUT.

The conversion circuit 35 converts the output image signal S3 inputted by the adjustment circuit 34 into an image signal in a three-dimensional color space and outputs an image signal S4 having undergone the conversion to the light modulator drive circuit 36. In the present embodiment, the conversion circuit 35 converts the HLS color space into the RGB color space, and the image signal S4 contains an R image signal, a G image signal, and a B image signal.

The light modulator drive circuit 36 drives the light modulator 22 on the basis of the image signal S4 inputted from the conversion circuit 35. For example, when the light modulator 22 includes liquid crystal display panels, the light modulator drive circuit 36 drives the liquid crystal display panels on the basis of the image signal S4 to draw an image in each of the liquid crystal display panels.

The LUT storage section 39 is connected to the adjustment circuit 34. The adjustment circuit 34 uses an LUT (lookup table) stored in the LUT storage section 39 to adjust the input image signal S2. The LUT storage section 39 has a storage area where a plurality of LUTs are stored, and the adjustment circuit 34 reads a necessary LUT from the LUT storage section 39. The LUT storage section 39 is provided by using a storage area of a ROM (not shown) provided in the control unit 10, a semiconductor storage device (not shown) connected to the control unit 10, or a ROM (not shown) or a flash memory (not shown) provided in the image processing unit 30. The LUT storage section 39 can instead be provided in a RAM (not shown), and in this case, when the projector 1 is started, an LUT is read from the ROM (not shown) to the LUT storage section 39.

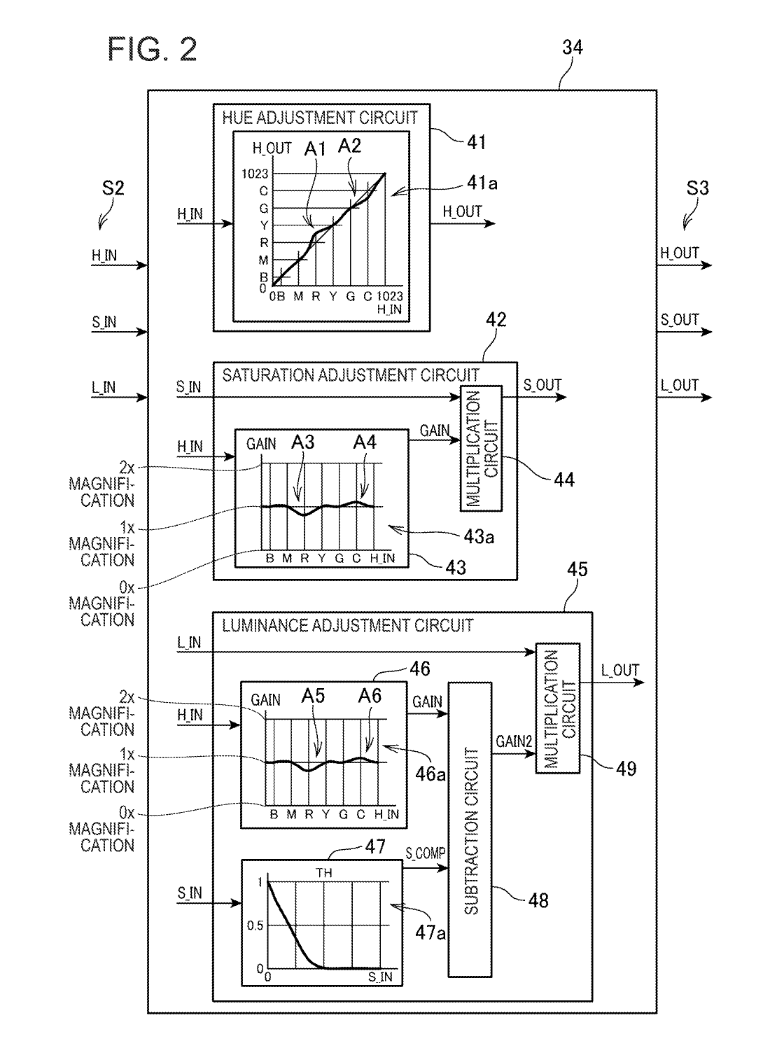

FIG. 2 shows the configuration of the adjustment circuit 34 in detail.

The adjustment circuit 34 includes a hue adjustment circuit 41, which adjusts the hue of the input image signal S2, a saturation adjustment circuit 42, which adjusts the saturation of the input image signal S2, and a luminance adjustment circuit 45 (luminance adjustment section), which adjusts the luminance of the input image signal S2.

The hue adjustment circuit 41 obtains, from a hue adjustment LUT 41a, an output value corresponding to the value of the hue input signal H_IN and outputs the output value as the hue output signal H_OUT. The hue adjustment LUT 41a is an LUT that stores values of the hue output signal H_OUT corresponding to values of the hue input signal H_IN. The projector 1 according to the present embodiment allows six-axis adjustment in which the hue, the saturation, and the luminance of C (cyan), G (green), Y (yellow), R (red), M (magenta), and B (blue) are adjusted. To this end, the hue adjustment LUT 41a shown in FIG. 2 by way of example contains hue adjustment values (output values) corresponding to the colors described above, C, G, Y, R, M, and B.

The hue adjustment LUT 41a is not limited to a table containing hue output signals H_OUT for all hue input signals H_IN and may contain values of the hue output signal H_OUT that correspond to a few representative hue input signals H_IN. When the value of a non-representative hue input signal H_IN is in question, the hue adjustment circuit 41 may perform interpolation on values contained in the hue adjustment LUT 41a and determine a hue output signal H_OUT corresponding to the non-representative hue input signal H_IN.

The hue adjustment LUT 41a shown in FIG. 2 by way of example is an LUT which performs linear conversion of the hue input signal H_IN and to which two characteristics labeled with reference characters A1 and A2 are added. Reference character A1 corresponds to a setting that changes the hue of R to a value close to the hue of Y, and reference character A2 corresponds to a setting that changes the hue of C to a value close to the hue of G. The hue adjustment circuit 41, which uses the hue adjustment LUT 41a, adjusts hue values of the hue input signal H_IN that are in the vicinity of R to values close to the hue of Y and further adjusts hue values of the hue input signal H_IN that are in the vicinity of C to values close to the hue of G.

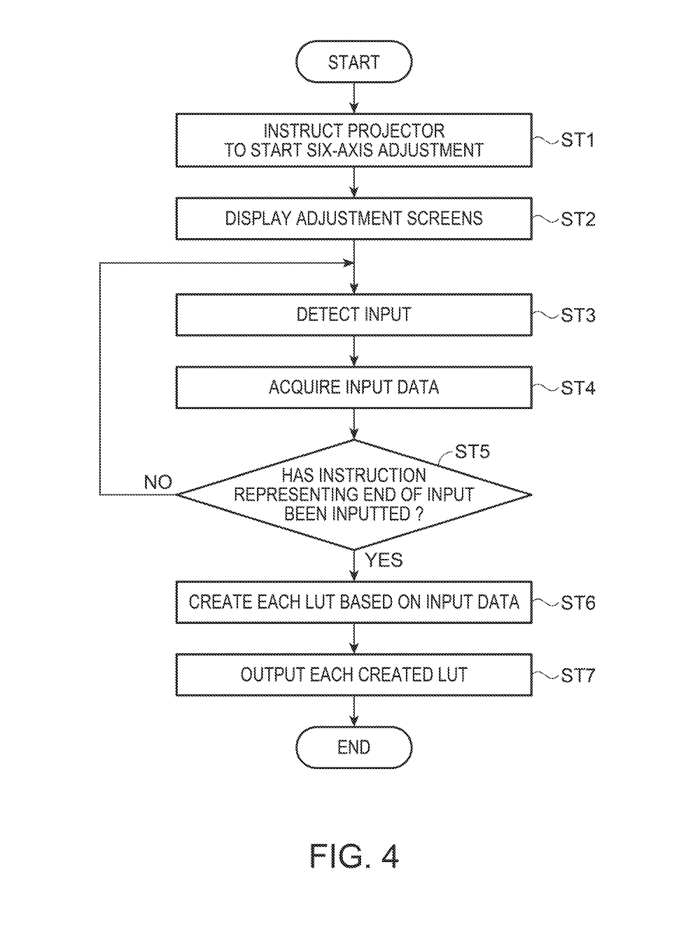

The hue adjustment LUT 41a, a saturation gain setting LUT 43a, and a luminance gain setting LUT 46a, which are used by the adjustment circuit 34, are created by the control unit 10 in accordance with operation performed on the operation panel 11 or the remote control 15 in an LUT creation process (FIG. 4), which will be described later. For example, the setting related to the characteristic labeled with each of reference characters A1 and A2 in the hue adjustment LUT 41a is specified by operation performed on the operation panel 11 or the remote control 15. The hue adjustment can therefore be performed in accordance with preference of the user who operates the projector 1.

The saturation adjustment circuit 42 includes a saturation gain setting section 43, which determines a saturation gain value (GAIN) by using the saturation gain LUT 43a, and a multiplication circuit 44, which multiplies the saturation input signal S_IN by the gain value determined by the saturation gain setting section 43.

The saturation gain setting LUT 43a is an LUT used to set the saturation gain on a hue basis. Specifically, the saturation gain setting LUT 43a contains saturation gain values corresponding to values of the hue input signal H_IN. The saturation gain setting LUT 43a shown in FIG. 2 by way of example contains two characteristics labeled with reference characters A3 and A4. Reference character A3 represents that the gain value is smaller than 1× magnification, and reference character A4 represents that the gain value is greater than 1× magnification. That is, reference character A3 corresponds to a setting that lowers the gain value for the saturation of R, and reference character A4 corresponds to a setting that increases the gain value for the saturation of C. The characteristics labeled with reference characters A3 and A4 correspond to those labeled with reference characters A1 and A2 in the hue adjustment LUT 41a. FIG. 2 is presented only by way of example, and the gain values provided in the saturation gain setting LUT 43a are not limited to those within the range from 0× to 2× magnification shown in FIG. 2.

The hue input signal H_IN and the saturation input signal S_IN are inputted to the saturation adjustment circuit 42, and the hue input signal H_IN is inputted to the saturation gain setting section 43. The saturation gain setting section acquires the gain value (GAIN) for the saturation corresponding to the hue input signal H_IN from the saturation gain setting LUT 43a and outputs the gain value to the multiplication circuit 44.

The gain value outputted by the saturation gain setting section 43 and the saturation input signal S_IN are inputted to the multiplication circuit 44. The multiplication circuit 44 multiplies the saturation input signal S_IN by the gain value and outputs the result of the multiplication as the saturation output signal S_OUT. The saturation adjustment circuit 42 thus amplifies or attenuates the saturation input signal S_IN by using the saturation gain setting LUT 43a and outputs the result of the amplification or attenuation.

The luminance adjustment circuit 45 includes a luminance gain setting section 46 (adjustment value setting section), a saturation correction value setting section 47 (correction value setting section), a subtraction circuit 48, and a multiplication circuit 49. The hue input signal H_IN, the saturation input signal S_IN, and the luminance input signal L_IN are inputted to the luminance adjustment circuit 45.

The hue input signal H_IN is inputted to the luminance gain setting section 46. The luminance gain setting section 46 determines a gain value for the luminance corresponding to the hue input signal H_IN by using the luminance gain adjustment LUT 46a (adjustment LUT).

The luminance gain setting LUT 46a is an LUT used to set the luminance gain on a hue basis. Specifically, the luminance gain setting LUT 46a contains gain values for the luminance corresponding to values of the hue input signal H_IN. The luminance gain setting LUT 46a shown in FIG. 2 by way of example contains two characteristics labeled with reference characters A5 and A6. Reference character A5 represents that the gain value is smaller than 1× magnification, and reference character A6 represents that the gain value is greater than 1× magnification. That is, reference character A5 corresponds to a setting that lowers the gain value for the luminance of R, and reference character A6 corresponds to a setting that increases the gain value for the luminance of C. The characteristics labeled with reference characters A5 and A6 correspond to those labeled with reference characters A1 and A2 in the hue adjustment LUT 41a and those labeled with reference characters A3 and A4 in the saturation gain setting LUT 43a. The luminance gain setting section 46 acquires again value corresponding to the hue input signal H_IN from the luminance gain setting LUT 46a and outputs the gain value (GAIN) to the subtraction circuit 48. FIG. 2 is presented only by way of example, and the gain values provided in the luminance gain setting LUT 46a are not limited to those within the range from 0× to 2× magnification shown in FIG. 2.

The saturation correction value setting section 47 determines a correction value used to correct the gain value outputted by the luminance gain setting section 46 by using a saturation correction value LUT 47a (correction LUT) and outputs the correction value. The saturation correction value LUT 47a is an LUT that stores correction values used to correct luminance gain values in relation to the value of the saturation input signal S_IN.

The saturation correction value LUT 47a has correction values greater than 0 in the area where the value of the saturation input signal S_IN is smaller than a threshold TH (low saturation area), and in the area where the value of the saturation input signal S_IN is greater than or equal to the threshold TH, correction values corresponding to the saturation input signal S_IN are 0, as shown in FIG. 2. In the low saturation area, the smaller the value of the saturation input signal S_IN, the greater the correction value. In the saturation correction value LUT 47a shown in FIG. 2 by way of example, the correction value has a minimum of 0 (when the saturation input signal S_IN is greater than or equal to the threshold TH), and the correction value has a maximum of 1 (when the saturation input signal S_IN is 0).

The saturation correction value setting section 47 outputs a correction value corresponding to the saturation input signal S_IN to the subtraction circuit 48.

The subtraction circuit 48 subtracts the correction value inputted by the saturation correction value setting section 47 from the gain value inputted by the luminance gain setting section 46 and outputs the gain value having undergone the subtraction (GAIN2: luminance correction value) to the multiplication circuit 49.

The gain value having undergone the subtraction (GAIN2) and outputted by the subtraction circuit 48 and the luminance input signal L_IN are inputted to the multiplication circuit 49. The multiplication circuit 49 multiplies the luminance input signal L_IN by the gain value (GAIN2) and outputs the value resulting from the multiplication as the luminance output signal L_OUT.

Creation of the hue adjustment LUT 41a, the saturation gain setting LUT 43a, and the luminance gain setting LUT 46a, which are used by the adjustment circuit 34, will be described.

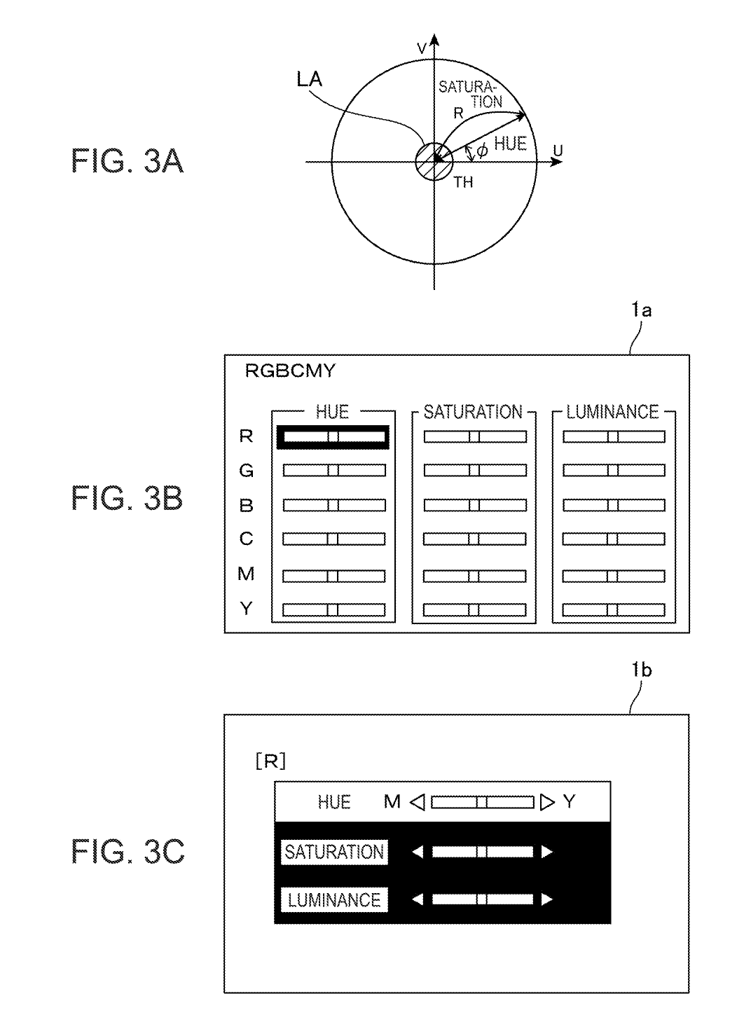

FIGS. 3A to 3C describe action of the projector 1. FIG. 3A is a diagrammatic view showing the color space of the polar coordinate system processed by the adjustment circuit 34. FIG. 3B shows an example of an adjustment screen 1a projected by the projector 1. FIG. 3C shows an example of an adjustment screen 1b projected by the projector 1. FIG. 4 is a flowchart showing action of the projector 1 and particularly shows the process of creating LUTs.

The image processing unit 30 instructs the conversion circuit 33 to cause it to convert the input image data D1 into an image signal in the color space of the polar coordinate system. The luminance, the saturation, and the hue in the converted color space can be expressed, for example, as shown in FIG. 3A. In FIG. 3A, the saturation R and the hue φ are shown in the U-V plane, and an angle θ (not shown) with respect to the Y axis, which is perpendicular to the plane of view, represents the luminance. Further, in FIG. 3A, reference character LA denotes the low saturation area where the value of the saturation input signal S_IN is smaller than the threshold TH.

In the projector 1, the six-axis adjustment can be performed in response to operation on the operation panel 11 or the remote control 15. The six-axis adjustment is shown in FIG. 4.

The control unit 10 of the projector 1, when it detects an instruction from the operation panel 11 or the remote control 15 to start the six-axis adjustment (step ST1), displays the adjustment screen 1a and further displays the adjustment screen 1b (step ST2). At this point, the control unit 10 detects input operation performed on the operation panel 11 or the remote control 15 (step ST3) and acquires data corresponding to the input operation (step ST4). The control unit 10 evaluates whether or not an instruction representing an end of the input has been inputted to the operation panel 11 or the remote control 15 (step ST5). When a result of the evaluation shows that the instruction has not been inputted, the control unit 10 returns to step ST3. When a result of the evaluation shows that the instruction representing an end of the input has been inputted, the control unit 10 proceeds to step ST6.

In step ST2, the projection unit 20 displays the adjustment screen 1a shown in FIG. 3B. The adjustment screen 1a allows the user to perform input operation of adjusting the hue, the saturation, and the luminance for each of R, G, B, C, M, and Y. When any of R, G, B, C, M, and Y is selected in the adjustment screen 1a as a color to be adjusted, the control unit 10 instructs the projection unit 20 to cause it to further project the adjustment screen 1b shown in FIG. 3C. FIG. 3C shows the adjustment screen 1b for R by way of example. In the adjustment screen 1b is drawn a cursor that specifies the direction and the amount of the adjustment of each of the hue, the saturation, and the luminance of the color to be adjusted. For example, the hue of the color R can be adjusted in the direction in which it approaches the hue of M or in the direction in which it approaches the hue of Y.

When operation of moving any of the cursors in the adjustment screen 1b is performed on the operation panel 11 or the remote control 15, the control unit 10 acquires the direction and the amount of movement of the cursor in the adjustment screen 1b in step ST4.

In step ST6, the control unit 10 creates the hue adjustment LUT 41a, the saturation gain setting LUT 43a, and the luminance gain setting LUT 46a on the basis of the data acquired in step ST4.

The control unit 10 then outputs the created LUTs (hue adjustment LUT 41a, saturation gain setting LUT 43a, and luminance gain setting LUT 46a) to the image processing unit 30, instructs the LUT storage section 39 to cause it to store the LUTs (step ST7), and terminates the procedure.

On the basis of inputted data on any one of the elements, the hue, the saturation, and the luminance, the control unit 10 creates LUTs corresponding to the other elements as required. For example, the control unit 10 creates the hue adjustment LUT 41a, which is used to adjust the hue, in correspondence with input data on adjustment of the hue of the color R and further creates the saturation gain setting LUT 43a and the luminance gain setting LUT 46a in correspondence with the adjustment of that hue.

The adjustment circuit 34 can use the thus created hue adjustment LUT 41a, saturation gain setting LUT 43a, and luminance gain setting LUT 46a to perform the HLS six-axis adjustment as shown in FIG. 2, whereby the user can adjust displayed colors as desired. However, the hue of a low-saturation color, when the color is adjusted by the adjustment circuit 34, greatly changes in some cases.

In the low saturation area LA shown in FIG. 3A, where the saturation R is small, a change in the hue φ sharply changes the tone of a color. That is, when the luminance of a color in the low saturation area LA is adjusted on a hue basis, the change in the luminance produces a very large change in the tone of the color.

For example, consider a case where adjustment is made on a color P produced by adding a small amount of green to an achromatic color (gray) and a color Q produced by adding a small amount of violet to an achromatic color. It is assumed that the colors P and Q before adjustment are colors that are close to achromatic colors and do not allow a viewer to sense a large difference in color tone. Adjustment is made on the colors P and Q by applying the saturation gain setting LUT 43a in which the gain for the green is set at 1.2× magnification and the gain for the violet is set at 0.8× magnification. As a result, the color P is adjusted to a color P′ clearly different from the achromatic color because the luminance of the green increases. In contrast, the color Q is adjusted to a color Q′ closer to the achromatic color because the luminance of the violet decreases. Since the color Q has almost no green component, the application of the saturation gain setting LUT 43a causes almost no change in the green component. In this example, adjusting the colors P and Q, which are close to achromatic colors, by using the same saturation gain setting LUT 43a causes the colors P′ and Q′ after the adjustment to greatly differ from each other in terms of color tone.

As shown in this example, when a color that belongs to the low saturation area LA is adjusted by using the saturation gain setting LUT 43a, a slight difference in color tone is amplified. Therefore, if noise is added to a color that belongs to the low saturation area LA, effect of the noise greatly changes the color tone after adjustment, possibly resulting in a decrease in the quality of an image after the adjustment.

In the projector 1 according to the present embodiment, the luminance adjustment circuit 45, which adjusts the luminance in the adjustment circuit 34, is provided with the saturation correction value setting section 47. In a low saturation area, that is, an area where the saturation is nearly zero, the saturation correction value setting section 47 outputs a correction value that attenuates the gain value outputted by the luminance gain setting section 46. As a result, the subtraction circuit 48 subtracts the correction value from the gain value from the luminance gain setting section 46 in the low saturation area, and the multiplication circuit 49 adjusts the luminance input signal L_IN by using the gain value having undergone the subtraction (GAIN2). Further, the saturation correction value LUT 47a is so configured to reduce the correction value in an area where the saturation is greater than or equal to the threshold TH, as shown in FIG. 2 by way of example. Therefore, in the case of a color that does not belong to the low saturation area, the luminance input signal L_IN is adjusted in accordance with the luminance gain setting LUT 46a, whereby the user can make intended adjustment. As a result, the projector 1 can prevent any excessive change in color tone in a low saturation area for suppression of an effect of noise and can adjust the luminance by a large amount in an area where the saturation is greater than in the low saturation area (high saturation area) without any change in the luminance gain setting LUT 46a.

Further, according to the configuration described above, in the process of creating the luminance gain setting LUT 46a, it is not necessary to distinguish between a low saturation area and the other area. The action and configuration of the projector 1 can therefore be achieved without any complication thereof, whereby convenience in the user's adjustment of an image is not compromised. Further, to reduce an effect of noise in a low saturation area, the saturation correction value LUT 47a does not need to be changed in correspondence with the content of the luminance gain setting LUT 46a. The saturation correction value LUT 47a may, of course, be changed, but a sufficiently advantageous effect can be provided even when the projector 1 is configured to use a fixed saturation correction value LUT 47a. Therefore, in the process of creating the luminance gain setting LUT 46a, there is no concern about an increase in processing burden on the control unit 10 as compared with a case where no saturation correction value LUT 47a is used, whereby an efficient process can be carried out.

The luminance adjustment circuit 45 only needs to allow the subtraction circuit 48 to correct, for at least one hue, the gain value outputted by the luminance gain setting section 46 by using the correction value from the saturation correction value setting section 47. Instead, the correction is not necessarily made for a specific hue, and the gain value from the luminance gain setting section 46 may be corrected by using the correction value from the saturation correction value setting section 47 for any hue.

As described above, the image processing unit 30 of the projector 1 according to the embodiment of the invention includes the adjustment circuit 34, which performs luminance adjustment on an input image signal containing elements formed of the luminance, the saturation, and the hue on a hue basis in accordance with an adjustment value in the luminance gain setting LUT 46a, which is created based on the input, and the adjustment circuit 34 sets, for at least one hue, the amount of adjustment (GAIN2) of the luminance in a low saturation area where the saturation is low to be smaller than the amount of adjustment (GAIN2) of the luminance in an area where the saturation is higher than in the low saturation area. As a result, when luminance adjustment is performed on an input image signal on a hue basis, an effect of noise can be suppressed.

The adjustment circuit 34, which has the saturation correction value LUT 47a containing correction values used to correct adjustment values used to adjust the luminance in a low saturation area and corrects an adjustment value in the luminance gain setting LUT 46a by using a correction value to determine an adjustment value used to adjust the luminance, can adjust the luminance to a value suitable for the low saturation area.

The adjustment circuit 34, which includes the subtraction circuit 48, can quickly produce an adjustment value suitable for the low saturation area and can hence suppress delay in processing.

The image processing unit 30 has the luminance gain setting LUT 46a and the saturation correction value LUT 47a containing correction values. The adjustment circuit 34 applies the hue of an input image signal to the luminance gain setting LUT 46a to determine an adjustment value (gain value) used to adjust the luminance, applies the saturation of the input image signal to the saturation correction value LUT 47a to determine a correction value, and applies the correction value to the adjustment value used to adjust the luminance to determine an adjustment value used to adjust the input image signal. The computation using the LUTs described above allows quick generation of an appropriate adjustment value, and the signal adjustment with a small amount of delay in processing allows suppression of an effect of noise, whereby a high-quality image signal can be outputted.

The adjustment circuit 34 further includes the luminance adjustment circuit 45, to which the hue input signal H_IN, which is a hue signal in an input image signal, the luminance input signal L_IN, which is a luminance signal in the input image signal, and the saturation input signal S_IN, which is a saturation signal in the input image signal, are inputted. The luminance adjustment circuit 45 includes the luminance gain setting section 46, which applies the hue input signal H_IN to the luminance gain setting LUT 46a to determine a gain value for the luminance. The luminance adjustment circuit 45 further includes the saturation correction value setting section 47, which applies the saturation input signal S_IN to the saturation correction value LUT 47a to determine a correction value. The luminance adjustment circuit 45 still further includes the subtraction circuit 48, which subtracts the correction value determined by the saturation correction value setting section 47 from the gain value determined by the luminance gain setting section 46, and the multiplication circuit 49, which multiplies the luminance input signal L_IN by the gain value having undergone the subtraction performed by the subtraction circuit 48. The luminance can therefore be appropriately adjusted for each hue on the basis of the hue input signal H_IN, the luminance input signal L_IN, and the saturation input signal S_IN.

The image processing unit 30 further includes the conversion circuit 33, which is connected to the image input I/F 31 (signal input section) through which the input image data D1 is inputted and performs polar coordinate conversion on an image signal inputted through the image input I/F 31, the polar coordinate conversion converting the image signal into the input image signal containing the elements formed of the luminance, the saturation, and the hue in apolar coordinate system. Therefore, luminance adjustment can be performed on a hue basis not only on an image signal in a polar coordinate system but also on an input image signal in any other color space.

The image processing unit 30 converts an YUV-color-space or RGB-color-space image signal inputted through the image input I/F 31 into an input image signal containing elements formed of the luminance, the saturation, and the hue in a polar coordinate system, adjusts the input image signal in accordance with an adjustment value, converts the adjusted input image signal into a YUV-color-space or RGB-color-space image signal, and outputs the converted image signal. Therefore, luminance adjustment on a hue basis in a polar coordinate color space can be performed on a YUV-color-space or RGB-color-space image signal, and the adjusted image signal can be outputted in the form of a YUV-color-space or RGB-color-space image signal.

Further, the projector 1 is configured to be capable of receiving inputs of adjustment values used to adjust the luminance, the saturation, and the hue for each of the six colors, R, G, B, C, M, and Y and performs the six-axis adjustment, in which the luminance, the saturation, and the hue of the six colors, R, G, B, C, M, and Y, on the basis of the inputted adjustment values. An effect of noise in the case where the six-axis adjustment is performed can therefore be suppressed, whereby a high-quality image signal can be outputted.

The embodiment described above is only an example of a specific aspect to which the invention is applied and is not intended to limit the invention, and the invention is also applicable in the form of an aspect different from the embodiment described above. For example, the image processing performed by the image processing unit 30 provided in the projector 1 is not limited to resolution conversion, zooming, color correction, intermediate frame generation, and the like, and the image processing unit 30 may perform other types of image processing. Further, each of the circuits that form the image processing unit 30 in FIG. 1 and the adjustment circuit 34 shown in FIG. 2 may be achieved by using an IC (integrated circuit) or an SoC (system-on-a-chip) or may be achieved by using software executed by a CPU or an MPU. FIGS. 1 and 2 are therefore not intended to limit the physical implementation of the image processing unit 30.

Further, the display apparatus according to the embodiment of the invention is not limited to the projector 1, which projects an image on the screen SC as described above, and a display system according to an embodiment of the invention may also include a variety of other display apparatus, such as a liquid crystal monitor or a liquid crystal television that displays an image on a liquid crystal display panel, a monitor apparatus or a television receiver that displays an image on a PDP (plasma display panel), a monitor apparatus or a television receiver that displays an image on an organic EL display panel, for example, called an OLED (organic light-emitting diode) and OEL (organic electro-luminescence), or other self-luminous display apparatus. In this case, the liquid crystal display panel, the plasma display panel, and the organic EL display panel correspond to the display section. Further, individual hardware corresponding to each of the functional portions of the projector 1 shown in FIG. 1 is not necessarily implemented, and a single processor that executes a program can, of course, achieve the functions of the plurality of functional portions except for the image processing unit 30.

What is claimed is:

1. A signal adjustment apparatus comprising
an adjustment section that performs luminance adjustment on an input image signal containing elements formed of luminance, saturation, and hue in accordance with an adjustment value on a hue basis,
wherein the adjustment section sets, for at least one hue, the amount of adjustment of the luminance in a low saturation area where the saturation is low to be smaller than the amount of adjustment of the luminance in an area where the saturation is higher than in the low saturation area.

2. The signal adjustment apparatus according to claim 1,
wherein the adjustment section has a correction value used to correct an adjustment value used to adjust the luminance in the low saturation area and corrects the adjustment value by using the correction value to determine a luminance adjustment value that specifies the amount of adjustment of the luminance.

3. The signal adjustment apparatus according to claim 2,
wherein the adjustment section includes a subtraction circuit that corrects the adjustment value by using the correction value.

4. The signal adjustment apparatus according to claim 2, further comprising:
an adjustment LUT created on the basis of an input value and containing the adjustment value; and a correction LUT containing the correction value,
wherein the hue of the input image signal is applied to the adjustment LUT to determine the adjustment value used to adjust the luminance, the saturation of the input image signal is applied to the correction LUT to determine the correction value, and the correction value is applied to the adjustment value used to adjust the luminance to determine the luminance adjustment value.

5. The signal adjustment apparatus according to claim 1,
wherein the adjustment section includes a luminance adjustment section to which a hue signal, a luminance signal, and a saturation signal that form the input image signal are inputted, and
the luminance adjustment section includes
an adjustment value setting section that applies the hue of the input image signal to the adjustment LUT to determine the adjustment value used to adjust the luminance,
a correction value setting section that applies the saturation of the input image signal to the correction LUT to determine the correction value,
a subtraction circuit that subtracts the correction value determined by the correction value setting section from the adjustment value determined by the adjustment value setting section to produce the luminance adjustment value, and
a multiplication circuit that multiplies the luminance signal by the luminance adjustment value produced by the subtraction circuit.

6. The signal adjustment apparatus according to claim 1, further comprising
a conversion section that is connected to a signal input section to which an image signal is inputted and performs polar coordinate conversion on the image signal inputted to the signal input section, the polar coordinate conversion converting the image signal into the input image signal containing the elements formed of the luminance, the saturation, and the hue in a polar coordinate system.

7. The signal adjustment apparatus according to claim 6,
wherein a YUV-color-space or RGB-color-space image signal inputted to the signal input section is converted into an input image signal containing the elements formed of the luminance, the saturation, and the hue in a polar coordinate system, and the input image signal is adjusted in accordance with the adjustment value, converted into a YUV-color-space or RGB-color-space image signal, and outputted.

8. The signal adjustment apparatus according to claim 1,
wherein adjustment values used to adjust the luminance, the saturation, and the hue are allowed to be inputted for each of six colors, R, G, B, C, M, and Y, and six-axis adjustment in which the luminance, the saturation, and the hue of the six colors, R, G, B, C, M, and Y, are adjusted on the basis of the inputted adjustment values is performed.

9. A display apparatus comprising:
a signal input section to which an image signal to be processed is inputted;
a control section that sets an adjustment value used to adjust the image signal;
an adjustment section that performs luminance adjustment on an input image signal containing elements formed of luminance, saturation, and hue on a hue basis in accordance with the adjustment value set by the control section; and
a display section that displays an image on the basis of the image signal adjusted by the adjustment section,
wherein the adjustment section sets, for at least one hue, the amount of adjustment of the luminance in a low saturation area where the saturation is low to be smaller than the amount of adjustment of the luminance in an area where the saturation is higher than in the low saturation area.

10. A signal adjustment method comprising:
performing luminance adjustment on an input image signal containing elements formed of luminance, saturation, and hue on a hue basis; and
setting, in the adjustment, for at least one hue, the amount of adjustment of the luminance in a low saturation area where the saturation is low to be smaller than the amount of adjustment of the luminance in an area where the saturation is higher than in the low saturation area.
